(19) United States
(12) Patent Application Publication
(10) Pub. No.: US 2015/0159425 A1
(43) Pub. Date: Jun. 11, 2015

(54) MAGNETICALLY ATTACHED FIXTURES AND METHODS OF MAKING THE SAME

(71) Applicant: 2Seal, LLC, Old Lyme, CT (US)

(72) Inventor: Martin G. Algar, Old Lyme, CT (US)

(73) Assignee: 2SEAL, LLC, Old Lyme, CT (US)

(21) Appl. No.: 14/567,238

(22) Filed: Dec. 11, 2014

Related U.S. Application Data
(60) Provisional application No. 61/914,549, filed on Dec. 11, 2013.

(51) Int. Cl. E06B 3/964; F16B 5/00; E06B 9/00; H01F 41/02; F16L 37/00

(52) U.S. Cl. CPC E06B 3/9646; H01F 41/0286; F16L 37/004; E06B 9/00; F16B 5/0032; E06B 2009/005

(57) ABSTRACT

The exemplary embodiments described herein include magnetically sealed enclosures comprising mitered edges, for example, an inside storm window or other window cover that can be mounted to a window frame by two magnetic tape strips, one which adheres to the frame and another which adheres to the window cover. The magnetic attraction between the tape strips, especially at the mitered edges assures an effective seal around the entirety of the enclosure.

### CROSS-REFERENCE TO RELATED APPLICATION

This application claims the benefit under 35 U.S.C. §119(e) to U.S. Provisional Patent Application Ser. No. 61/914,549, filed Dec. 11, 2013 and titled: Magnetically Attached Fixtures and Methods of Making the Same, which is incorporated herein by reference in its entirety.

### FIELD OF THE INVENTION

This invention relates to magnetically attached fixtures or articles, and devices having magnetically attached fixtures having magnetic tape strips with a mitered edge configuration, and methods of making the same.

### BACKGROUND INFORMATION

It has been an aim in the art to design a convenient system for the reversible attachment and detachment of fixtures or articles, e.g., covers, gas and liquid vents or valves, screens, doors, windows, storm windows, etc. However, it is has been difficult to create a means of fastening such articles such that the association is robust enough to withstand significant force (e.g., shear forces) and, at the same time, is able to be conveniently and/or easily removed or detached. In addition, a shortcoming of current technologies is the inability to form a substantially air and/or liquid tight seal.

One approach that has been explored is the use of magnets, such as magnetic tape strips that contain rubber bonded magnetized ferrite. However, using current methods, attaching or fixing an article using magnetic tape demonstrates relatively weak resistance to shear forces, and an inability to form a gas or liquid tight seal.

Thus, an ongoing need exists for systems and methods that allow for the reversible attachment/detachment of fixtures or articles but that provides an association that is sufficiently robust to withstand significant shear forces, and is also capable of forming a substantially gas and/or liquid tight seal.

### SUMMARY

The present description provides compositions, systems and methods for reversibly affixing/detaching articles using, e.g., magnetic tape strips. Magnetic strips are aligned in anti-parallel fashion such that strips are oriented to magnetically attract one another at all points along the strip, and affixed to the article to be attached (e.g., storm window) and to the substrate surface (e.g., window frame). It was surprising and unexpectedly discovered that instead of aligning the flush ends of the magnetic strip at the corners; a more robust association (i.e., stronger magnetic attraction) could be formed by mitering the magnetic strip. Indeed, it was surprisingly unexpectedly discovered that the mitered corners provided a seal that was significantly more resistant to the passage of air (i.e. gas) and/or liquid. Because of the greater force of the magnetic attraction in the corners as described herein, it is possible to create more energy efficient enclosures, e.g., covers, gas and liquid vents or valves, doors, windows, storm windows or other window cover.

Accordingly, in one aspect the description provides a reversibly attachable fixture or article having at least one corner and at least one surface comprising a magnetic strip affixed to a surface of the fixture or article, wherein the magnetic strip is mitered at the at least one corner of the same surface. In certain embodiments, the fixture or article comprises mitered magnetic strips at each corner. In additional embodiments, the magnetic strip is affixed to the fixture or article using an adhesive. In still additional embodiments, the magnetic strip is affixed at the at least one surface and apposed with an edge of the fixture. In another embodiment, the fixture is selected from the group consisting of a vent, a valve, a window cover, and a storm window.

In an additional aspect, the description provides a device comprising a reversibly attachable fixture comprising (i) a body or frame defining at least one corner and at least one substantially planar surface, and including a first magnetic strip affixed to the at least one substantially planar surface apposed or juxtaposed with an edge of the substantially planar surface, wherein the first magnetic strip is mitered at the at least one corner of the same surface; and (ii) a fixture comprising at least one corner and having at least one substantially planar surface, and including a second magnetic strip affixed to at least one substantially planar surface of the fixture, wherein the second magnetic strip is mitered at the at least one corner of the same surface, wherein the first and second magnetic strips are positioned such that said first strip is generally coextensive with the second strip, and wherein the magnetic poles of the first strip are in registration with the opposite magnetic poles of the second strip to maximize the magnetic attraction between the first strip and second strip such that the magnetic attraction is sufficient to create a seal that inhibits the passage of air and/or liquid. Stated differently, the strips are oriented to magnetically attract one another at all points around the apposed surfaces, especially at the corners. In certain embodiments, the seal is substantially air and/or liquid tight. In additional embodiments, the body or frame is a window frame and the fixture is a storm window. In another embodiment, the body or frame is an aperture of, e.g., an air or liquid conduit, and the fixture is a cover or panel. In certain embodiments, the cover or panel forms a vent or valve.

In an additional aspect, the description provides a method of releasably or reversibly attaching an fixture to a body or frame having at least one corner (e.g., attaching an aperture cover or panel to a frame surrounding the aperture), the method comprising the steps of: (a) selecting a continuous and substantially planar surface on the frame (e.g., frame enclosing said aperture); (b) providing first and second magnetic strips, each strip having an adhesive side and an opposite magnetic side, the magnetic side having spatially alternating north and south magnetic poles thereon; (c) mitering the first and second magnetic strips to form a miter joint in the at least one corner of the frame and fixture; (d) applying the adhesive side of the first strip to a surface on the fixture, e.g., in a pattern to generally continuously surround the frame or aperture; (e) positioning the magnetic side of the second strip on the magnetic side of the first strip such that the second strip is generally coextensive with the first strip; (f) adjusting the second strip in relation to the first strip to position the magnetic poles of the second strip in registration with opposite magnetic poles of the first strip to maximize the magnetic attraction between the first and second strips; and (g) thereafter placing a second of the surface or the fixture in contact with the adhesive side of said second strip such that said fixture is removably held, e.g., so as to cover said aperture, by the magnetic attraction between the magnetic sides of the first and second magnetic strips such that the magnetic attraction is sufficient to create a seal that inhibits the passage of air and/or liquid. In certain embodiments, the body or frame is an indoor surface of a window frame surrounding a window and the fixture is a storm window or other weather sealing cover for the window. In another embodiment, the body or frame is an aperture of, e.g., an air or liquid conduit, and the fixture is a cover or panel, e.g., forming a vent or valve.

In any of the aspects or embodiments described herein, the magnetic strip tape may comprise one or more bipolar axially disposed magnetic strips aligned parallel and affixed to each other (see, e.g., FIG. 5). For example, the magnetic strip can comprise 2, 3, 4, 5, 6, 7, 8, 9, 10 or more magnetic strips juxtaposed and/or bonded together into a single strip. In addition, in any of the aspects or embodiments described herein, the magnetic strip can be an anisotropic magnetic strip. For example, in any of the aspects or embodiments described herein, the magnetic strip can be a bipolar anisotropic/uniaxial anisotropy dual strip magnet.

In an additional aspect, the description provides kits comprising one or more containers comprising any of the compositions as described herein. In certain embodiments, the kit comprises instructions for performing a method as described herein.

The present invention further provides any invention described herein.

The preceding general areas of utility are given by way of example only and are not intended to be limiting on the scope of the present disclosure and appended claims. Additional objects and advantages associated with the compositions, methods, and processes of the present invention will be appreciated by one of ordinary skill in the art in light of the instant claims, description, and examples. For example, the various aspects and embodiments of the invention may be utilized in numerous combinations, all of which are expressly contemplated by the present description. These additional advantages objects and embodiments are expressly included within the scope of the present invention. The publications and other materials used herein to illuminate the background of the invention, and in particular cases, to provide additional details respecting the practice, are incorporated by reference, and for convenience are listed in the appended bibliography.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating an embodiment of the invention and are not to be construed as limiting the invention. Further objects, features and advantages of the invention will become apparent from the following detailed description taken in conjunction with the accompanying figures showing illustrative embodiments of the invention, in which:

FIG. 1. Illustrates the typical configuration of magnetic strip tape as currently performed in the art. N and S denote the poles of the respective magnetic strips. Because of the magnetic flux lines, only a weak attraction is possible with this corner configuration of magnetic strips. As such, the weak attraction allows for the generally undesirable passage of air and/or liquids through the corners.

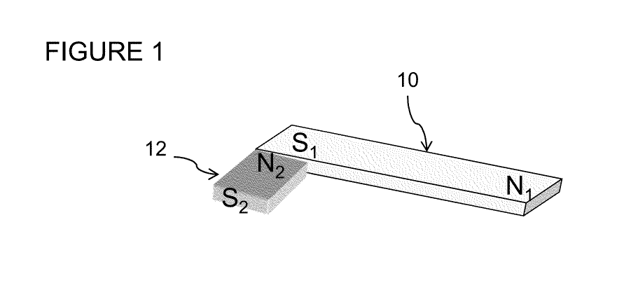

FIG. 2. Illustrates the mitered corner magnetic strip configuration as presently described. A, The Greek letter, theta, indicates the angle that the strip is cut. In general, the two miters will be cut at the same angle so as to conform to the desired angle of the corner (e.g., 45°+45° for a 90° corner). B, The mitered magnetic strips are combined and affixed to both the frame or body (e.g., 24/25) and the fixture (26/27), respectively.

FIG. 3. Illustrates the mitered corner magnetic strip configuration using a multi-strip magnetic as presently described. A, The Greek letter, theta, indicates the angle that the strip is cut. In general, the two miters will be cut at the same angle so as to conform to the desired angle of the corner (e.g., 45°+45° for a 90° corner). B, A much stronger magnetic attraction is achieved using mitered joints and multi-strip magnetic strips. The mitered magnetic strips are combined and affixed to both the frame or body (e.g., 34/35) and the fixture (36/37), respectively.

FIG. 4. Demonstrates the antiparallel association of a dual-strip magnetic strip suitable for use in compositions and methods as described herein. The magnetic poles of the magnetic side of the respective magnetic strips are brought into registration with the opposite magnetic poles of the other strip

FIG. 5. Illustrates an exemplary embodiment as provided by the present description. 1. Panel; 2. (for each magnetic strip magnet) South magnetic pole; 3. (for each magnetic strip magnet) North magnetic pole; 4. Double sided tape; 5. PVC frame.

FIG. 6. Illustrates an exemplary embodiment of a releasingly or reversibly attachable fixture as provided by the present description. A and B depict a conduit, e.g., for carrying gas or liquid. The conduit has an aperture and the frame surrounding the aperture and the edges of the cover or panel are lined with a magnetic strip, wherein the magnetic strip is mitered at the corners of the frame and at the corners of the cover or panel. In this example, the panel contains a hinge on one end and partially releases or detaches (B) in response to a sufficient force allowing the gas and/or liquid to pass through (although the invention is not so limited). As the force drops, the cover or panel securely closes due to the magnetic attraction between the strips on the frame and the cover or panel, returning to the closed position (A).

### DETAILED DESCRIPTION

The following is a detailed description of the invention provided to aid those skilled in the art in practicing the present invention. Those of ordinary skill in the art may make modifications and variations in the embodiments described herein without departing from the spirit or scope of the present invention. Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. All publications, patent applications, patents, figures and other references mentioned herein are expressly incorporated by reference in their entirety.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges which may independently be included in the smaller ranges is also encompassed within the invention, subject to any specifically excluded limit in the stated range. Where the stated range includes one or both of the limits, ranges excluding either both of those included limits are also included in the invention.

Although any methods and materials similar or equivalent to those described herein can also be used in the practice or testing of the present invention, the preferred methods and materials are now described. All publications mentioned herein are incorporated herein by reference to disclose and described the methods and/or materials in connection with which the publications are cited.

It must be noted that as used herein and in the appended claims, the singular forms “a”, “and”, and “the” include plural references unless the context clearly dictates otherwise. All technical and scientific terms used herein have the same meaning.

Definitions

Unless defined otherwise, all technical and scientific terms used herein have the meaning commonly understood by a person skilled in the art to which this invention belongs. However, it should be understood that other meanings that are known or understood by those having ordinary skill in the art are also possible, and within the scope of the present invention. All publications, patent applications, patents, and other references mentioned herein are incorporated by reference in their entirety. In the case of conflict, the present specification, including definitions, will control. In addition, the materials, methods, and examples are illustrative only and not intended to be limiting.

In order that the present invention may be more readily understood, certain terms are first defined.

The term “magnet” can mean, but is in no way limited to, an object made of certain materials which create a magnetic field. Every magnet has at least one north pole and one south pole. By convention, it is said that the magnetic field lines leave the North end of a magnet and enter the South end of a magnet. This is an example of a magnetic dipole (“di” means two, thus two poles).

The term “Gauss” can mean, but is in no way limited to, a unit of measure of magnetic induction, B, or flux density in the CGS system. Most manufacturers of permanent magnets use the term “gauss rating” to characterize their products. however, this term is misleading since “gauss rating” characterizes the core of the magnet but not the magnetic field on the surface of the magnet. A Gaussmeter is generally used to measure the instantaneous value of magnetic induction, B.

The term “anisotropic” can mean, but is in no way limited to, unequal physical properties along different axes. As the term applies to magnetic strip tape, the term “anisotropic” can mean, but is in no way limited to, the property that the direction of the magnetic field is stronger along a certain axis or orientation.

The term “bipolar” can mean, but is in no way limited to, magnets that have a repeatable north/south polarity on the same side of the magnet. These magnets are usually thin and flexible, e.g., magnetic strip tape.

The term “corner” can mean, but is in no way limited to, the place at which two converging lines or surfaces meet; preferably has an angle (theta) of less than 180 degrees (e.g., 90 degrees).

The term “miter” (or “miter joint”) can mean, but is in no way limited to, an oblique surface formed so as to abut against another oblique surface to be joined with it. A miter joint, sometimes shortened to miter, is a joint made by beveling each of two parts to be joined, usually at a 45° angle, to form a corner. For miter joints occurring at angles other than 90°, for materials of the same cross-section the proper cut angle must be determined so that the two pieces to be joined meet flush (i.e. one piece's mitered end is not longer than the adjoining piece). To find the cut angle divide the angle at which the two pieces meet by two. Technically two different cut angles are required; one for each piece, where the second angle is 90° plus the aforementioned cut angle.

The term “fixture” is used in a broad sense and can mean, but is in no way limited to, an article to be affixed, attached or appended, including, e.g., a panel, cover, gas and/or liquid vent or valve, door, window, storm window, window screen, or other window cover. In certain embodiments, the fixture is releasably or reversibly attached. In certain other embodiments, the fixture is a cover placed over an aperture, such as on an air/gas or a liquid conduit. In certain other embodiments, the fixture is a cover to be affixed to a window frame and includes a screen, or storm window.

The term “U-value” (or U-factor), called the overall heat transfer coefficient, describes how well a material conducts heat. It measures the rate of heat transfer through a material over a given area, under standardized conditions. The usual standard is at a temperature gradient of 24 ° C., at 50% humidity with no wind (a smaller U-value is better). U is the inverse of R with SI units of W/(m²K) and US units of BTU/(h° F. ft²);

$$U = \frac{1}{R} = \frac{{\dot{Q}}_{A}}{Δ T} = \frac{k}{L} ;$$

where k is the material's thermal conductivity and L is its thickness.

The term “R-value” is a measure of thermal resistance. Under uniform conditions it is the ratio of the temperature difference across an insulator and the heat flux (heat transfer per unit area, Q_{A}) through it or R=ΔT/Q_{A}.

This is used for a unit value of any particular material. It is expressed as the thickness of the material divided by the thermal conductivity. For the thermal resistance of an entire section of material, instead of the unit resistance, divide the unit thermal resistance by the area of the material. For example, if you have the unit thermal resistance of a wall, divide by the cross-sectional area of the depth of the wall to compute the thermal resistance. The unit thermal conductance of a material is denoted as C and is the reciprocal of the unit thermal resistance. This can also be called the unit surface conductance and denoted by h. The bigger the number, the better the insulator's effectiveness. R-value is the reciprocal of U-value. R-values are given in SI units, typically square-meter kelvins per watt or m²·K/W (or equivalently to m²·° C./W). In the United States customary units, R-values are given in units of ft²·° F·h/Btu.

Compositions

The present description provides compositions, systems and methods for reversibly affixing/detaching articles using, e.g., magnetic tape strips. Magnetic strips are aligned in anti-parallel ashion such that strips are oriented to magnetically attract or pull one another at all points along the strip including the corners. The strips are then affixed to the article to be attached (e.g., storm window) and to the substrate surface (e.g., window frame). It was surprising and unexpectedly discovered that instead of aligning the flush ends of the magnetic strip at the corners; a more robust association (i.e., stronger magnetic attraction) could be formed by mitering the magnetic strip. Indeed, it was surprisingly unexpectedly discovered that the mitered corners provided a seal that was significantly more resistant to the passage of air (i.e. gas) and/or liquid.

The reason that a pair of mutually attractive magnetic tape strips have not been successfully used in the past is believed to be related to difficult problems that are encountered in achieving continuous magnetic attraction of the tapes completely around the frame, in particular, in the corners of the frame and fixture. If the tape strips repel one another at any point, a gap is created and the fixture is ineffective in forming an air/gas and/or liquid tight seal. Due to the alternating polarity pattern of magnetic tape, it is highly difficult to place two long pieces of tape together such that they attract one another at all points along their lengths. Therefore, the tape cannot simply be applied to the window frame and to the storm window in random fashion since there are almost inevitably places where the polarities are misaligned. Random application of the tape thus invariably results in magnetic repulsion between the tapes and gaps at the points of repulsion.

We have overcome this problem by assuring that the two tape strips are properly oriented to attract one another magnetically before the tape strips are attached to both the fixture, e.g., storm window, and the frame, e.g., window frame. In addition, we have overcome the problem of incomplete seal in the corner by utilizing a mitered joint configuration. It has also been discovered that anisotropic magnetic tape strips are particularly advantageous for use in affixing the fixture to the frame. Furthermore, it has been discovered that multi-pole magnetic strip tape provides a robust association that provides improved resistance to shear forces, and an improved seal that substantially air/liquid tight and, therefore, has a relatively low heat transfer coefficient (i.e., has good thermal resistance).

Thus, the description provides devices having one strip of magnetic tape on a frame, e.g., a window frame, and another tape strip on a fixture or cover, e.g., a storm window, screen or other type of window cover. The magnetic strips adhere to one another to securely hold the fixture, e.g., window cover, in place while permitting it to be easily removed and replaced as desired. In accordance with the invention, the first tape strip is adhesively attached to the window frame in extension around the window. The second strip, while loose from the storm window, is applied to the magnetic side of the first strip and is positioned such that there is magnetic attraction between the two strips at all points. Only then is the storm window applied to the adhesive side of the second strip. In this manner, a tight seal between the storm window and frame is assured completely around the window, and there are no points where the tape strips repel one another. The storm window can be removed and replaced with assurance that the magnetic tape strips will be properly oriented to attract one another at all points to thus provide an effective seal between the storm window and the window frame.

Previous attachments use a butt joint for the magnet strip configuration. A butt joint is a joinery technique in which two members are joined by simply butting them together. This joinery places the strip magnetic poles in repulsion at the corner joints. Using a miter joint cut, e.g., using an oriented bipolar magnetic strip, a corner seal is formed that results in an overall seal that is far more continuous than that of a butt joint using a normal dipole magnetic strip magnetic seal. Because of the greater force of the magnetic attraction in the corners as described herein, it is possible to create more energy efficient enclosures, e.g., covers, gas and liquid vents or valves, doors, windows, storm windows or other window covers.

Attention is paid to the end-to-end spatiality of the cut magnetic two pole tape in the corners, alternating north and south magnetic poles, that is coextensive with the first strip in order to maximize the magnetic attraction (magnetic pull) between first and second strip at the of a geometric corner. In order to create a closed magnetic circuit when two or more ends of a two pole magnetic strip are connected together, both the joints and the faces of the two magnetic strips, are oriented to attract each other in a path of least resistance in a closed loop, specifically in the mitered corners. A pair of mutually attractive magnetic tape strips create a continuous magnetic attraction achieving a closed magnet circuit seal completely around the panel opening, including the corners. This has not been successfully duplicated.

If the magnetic tape strips repel one another, (as is the case with the butted corners) at any point, a gap is created and the panel will not seal effectively, due to the alternating polarity pattern of magnetic two pole tape. This affects not only the seal of the panel but also the release of the panel. Whereas the release of the magnetic pull is discharged with mitered corner configuration more easily, the release of butt jointed magnetic strips becomes compromised by the lack of pull strength in the corners of specific geometric shapes. Random application of the tape thus invariably results in magnetic repulsion between the tapes and gaps the magnetic pull at the points of repulsion. To overcome this problem, the two tape strips are properly oriented to attract one another, magnetically, both face to face, at every point along the length of the magnetic strips, including at the ends of the mitered joints before the tape strips are attached to both the panel, and the panel frame.

In accordance with the above, both tape strips are organized and identified as to the polar aspect of the strip, in all respects both face and mitered corner orientation. They are then positioned such that there are magnetic attraction between the two strips at all points. With this application, a tight magnetic seal between the panel and frame is assured continuously around the panel, and there are no points where the tape strips repel one another. The panel can be removed and replaced with assurance that the magnetic tape strips will be properly oriented to attract one another at all points to thus provide an effective seal between the storm window and the window frame.

Accordingly, in another aspect the description provides a reversibly attachable fixture having at least one corner and at least one surface comprising a magnetic strip affixed to a surface of the fixture or article, wherein the magnetic strip is mitered at the at least one corner of the same surface. In certain embodiments, the fixture or article comprises mitered magnetic strips at each corner. In additional embodiments, the magnetic strip is affixed to the fixture or article using an adhesive. In still additional embodiments, the magnetic strip is affixed at the at least one surface and apposed with an edge of the fixture. In another embodiment, the fixture is selected from the group consisting of a cover, a panel, a vent, a valve, a window cover, a screen, and a storm window.

In an additional aspect, the description provides a device comprising a reversibly attachable fixture comprising (i) a body or frame defining at least one corner and at least one substantially planar surface, and including a first magnetic strip affixed to the at least one substantially planar surface apposed or juxtaposed with an edge of the substantially planar surface, wherein the first magnetic strip is mitered at the at least one corner of the same surface; and (ii) a fixture comprising at least one corner and having at least one substantially planar surface, and including a second magnetic strip affixed to at least one substantially planar surface of the fixture, wherein the second magnetic strip is mitered at the at least one corner of the same surface, wherein the first and second magnetic strips are positioned such that said first strip is generally coextensive with the second strip, and wherein the magnetic poles of the first strip are in registration with the opposite magnetic poles of the second strip to maximize the magnetic attraction between the first strip and second strip such that the magnetic attraction is sufficient to create a seal that inhibits the passage of air and/or liquid. Stated differently, the strips are oriented to magnetically attract one another at all points around the apposed surfaces, especially at the corners. In certain embodiments, the seal is substantially air and/or liquid tight. In additional embodiments, the body or frame is a window frame and the fixture is a storm window. In another embodiment, the body or frame is an aperture of, e.g., an air or liquid conduit, and the fixture is a cover or panel. In certain embodiments, the cover or panel forms a vent or valve.

In still additional embodiments, the magnetic strip is affixed at the at least one surface and apposed with an edge of the fixture and/or affixed to at least one surface and apposed with each edge of the fixture. However, the invention is not so limited. For example, it is contemplated that in some instances, it may be more desirable to affix the magnetic strips a location other than the edges of the fixture and/or substrate. Such configurations are expressly contemplated.

In certain embodiments, the strength of the magnetic field (i.e., the magnetic attraction or pull) of the magnetic tape strips is relatively uniform at all points along the magnet surface. However, it is contemplated that certain applications will necessitate differences in the strength of the magnetic field at select points. Therefore, certain embodiments are also contemplated that included the use of magnetic tape strips having the same or different magnetic field strengths.

Methods

In an additional aspect, the description provides a method of releasably or reversibly attaching an fixture to a body or frame having at least one corner (e.g., attaching an aperture cover or panel to a frame surrounding the aperture), the method comprising the steps of: (a) selecting a continuous and substantially planar surface on the frame (e.g., frame enclosing said aperture); (b) providing first and second magnetic strips, each strip having an adhesive side and an opposite magnetic side, the magnetic side having spatially alternating north and south magnetic poles thereon; (c) mitering the first and second magnetic strips to form a miter joint in the at least one corner of the frame and fixture; (d) applying the adhesive side of the first strip to a surface on the fixture, e.g., in a pattern to generally continuously surround the frame or aperture; (e) positioning the magnetic side of the second strip on the magnetic side of the first strip such that the second strip is generally coextensive with the first strip; (f) adjusting the second strip in relation to the first strip to position the magnetic poles of the second strip in registration with opposite magnetic poles of the first strip to maximize the magnetic attraction between the first and second strips; and (g) thereafter placing a second of the surface or the fixture in contact with the adhesive side of said second strip such that said fixture is removably held, e.g., so as to cover said aperture, by the magnetic attraction between the magnetic sides of the first and second magnetic strips such that the magnetic attraction is sufficient to create a seal that inhibits the passage of air and/or liquid. In certain embodiments, the body or frame is an indoor surface of a window frame surrounding a window and the fixture is a storm window or other weather sealing cover for the window. In another embodiment, the body or frame is an aperture of, e.g., an air or liquid conduit, and the fixture is a cover or panel, e.g., forming a vent or valve.

This method utilizes one adhesively fixed flexible magnetic strip tape on a panel frame mitered in the corners and another flexible magnetic tape strip around the perimeter of a panel/window where the magnetic strips are mitered in the corners. The magnetic strips adhere to one another to securely hold the window/panel cover in place while permitting it to be easily removed and replaced as desired. The removal and magnetic hold (magnetic pull) are far superior to a butt joint assembly, and can be directly determined by the “pull strength” of the opposing magnetic strips in this application with specific attention to the corners of the geometric application.

A method of reversibly attaching a storm window to a rectangular window frame comprising the steps of: (a) selecting a continuous and substantially planar surface on the window frame; (b) providing first and second magnetic strips, each strip having an adhesive side and an opposite magnetic side, the magnetic side having multiple alternating north and south magnetic poles thereon; (c) mitering the first and second magnetic strips to form a miter joint in at least one corner of the window frame and storm window; (d) applying the adhesive side of the first strip to a surface on the storm window in a pattern to generally continuously surround the window frame; (e) positioning the magnetic side of the second strip on the magnetic side of the first strip such that the second strip is generally coextensive with the first strip; (f) adjusting the second strip in relation to the first strip to position the magnetic poles of the second strip in registration with opposite magnetic poles of the first strip along the sides and mitered corners to maximize the magnetic attraction between the first and second strips; and (g) thereafter placing the storm window in contact with the adhesive side of said second strip such that said storm window is removably held by the magnetic attraction between the magnetic sides of the first and second magnetic strips such that the magnetic attraction is sufficient to create a seal that prevents the passage of air and/or liquid, including through the corners.

In an additional aspect, the description provides methods of assembling two anisotropic flexible two pole magnetic tape strips to create a closed circuit magnetic seal to attaching a covering panel to a frame.

In another aspect, the description provides a method of releasably installing a weather sealing member on a window comprising the steps of: (a) providing first and second strips, each strip having an adhesive side and an opposite magnetic side, said magnetic side having spatially alternating north and south magnetic poles thereon; (b) applying the adhesive side of said first strip in abutting segments to an indoor surface of a generally rectangular frame surrounding said window so as to generally surround said window; (c) mitering the first and second magnetic strips to form a miter joint in at least one corner of the generally rectangular frame; (d) positioning the magnetic side of said second strip on the magnetic side of said first strip such that said second strip generally extends along said first strip and surrounds said window; (e) adjusting said segments of said second strip in relation to said first strip to position the magnetic poles of said second strip in registration with the opposite magnetic poles of said first strip to maximize the magnetic attraction of said second strip to said first strip; (f) thereafter attaching a weather sealing cover member over said window and securing said weather sealing cover member to the adhesive side of said second strip in covering relationship relative to said window such that said panel is securely but releasably (i.e., reversibly affixed and removed) held over said window by the attraction between the magnetic sides of said first and second magnetic strips; and optionally (g) providing aligned indicia on said first and second strips such that upon removal of said cover member from said surface and subsequent replacement thereon, said second strip may be accurately positioned for alignment of the magnetic poles thereof with the opposite magnetic poles of said first strip.

Kits

In an additional aspect, the description provides kits comprising one or more containers comprising any of the compositions as described herein. In certain embodiments, the kit comprises instructions for performing a method as described herein. In an exemplary embodiment, the description provides a kit comprising a container, a fixture, and a magnetic tape strip, wherein the magnetic tape includes mitered joints for sealing the corners of the fixture, and instructions for their use as described herein. In another exemplary embodiment, the description provides a kit comprising a fixture including magnetic tape strips affixed thereon, wherein the magnetic tape strips have mitered joints.

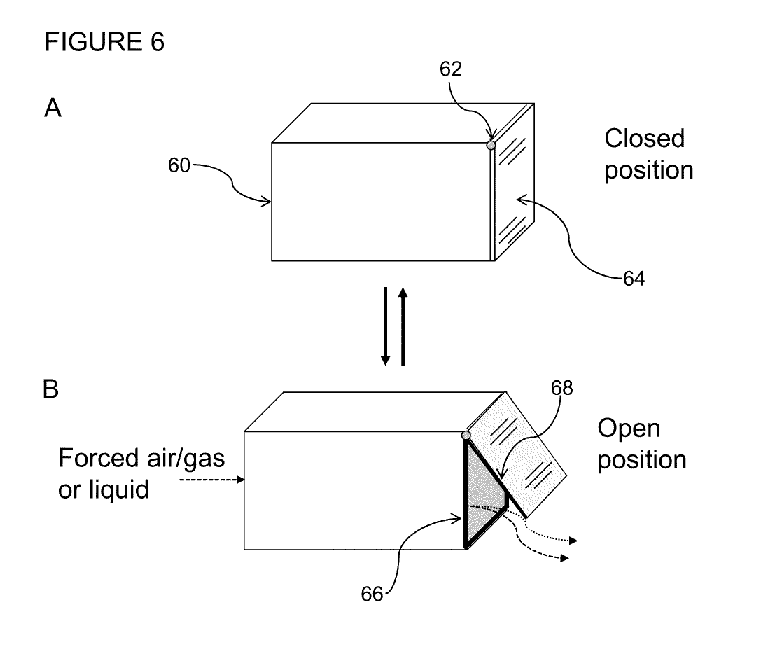

As indicated above, it will be recognized by the skilled artisan that one can vary the strength of magnetic strips as described herein to fit any particular specification or need of system. For example, magnetic tape strips having lower field strength can be used such that the fixture or cover gives way upon the exertion of a certain force (e.g., FIG. 6).

In a preferred embodiment, the magnetic strip is a bipolar anisotropic/Uniaxial anisotropy dual strip magnet. Magnets suitable for use in the devices and methods described herein are manufactured by Flexmag Industries, Inc. (Marietta, Ohio), for example, the Flexmag FM-60 Anisotropic Magnetic strips to mechanically attach a panel with no mechanical fastenings able to release and reattach under a certain pressure load. This magnet has side magnetism and a anisotropic strong face side and weak side. However, magnet strips having a variety of anisotropic configurations are contemplated as within the scope of the present description including more than two poles on one side.

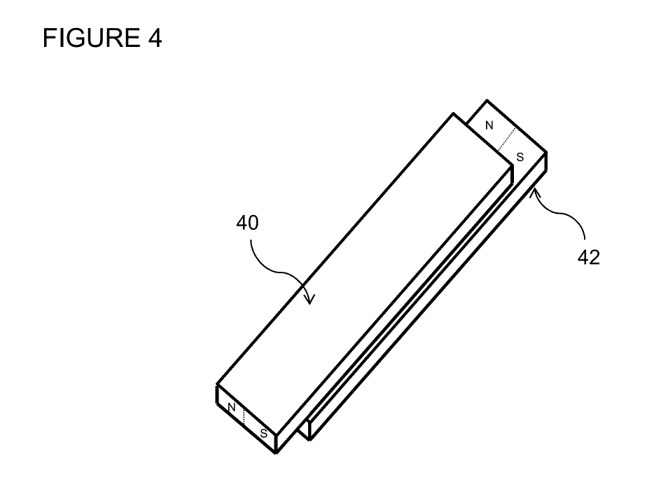

FIG. 4, shows an exemplary magnetic strip suitable for use in the described compositions and methods. The magnet-to-magnet strip is magnetized in a special configuration so that one magnet strip 40 will magnetically attract another magnetic strip 42. In certain embodiments, the magnetic strips have grooves or perforations such that the two magnetic strips interlock or snap into the proper position every time. It is also contemplated that the magnetic tape strips be of any suitable thickness or wideness. For example, in certain embodiments, the magnetic strip is from 0.1″ to 12″ wide. In certain embodiments, the magnetic strip is from 0.01″ to 1″ thick.

Magnetic strips can be of any desired strength, which can vary depending on the intended use and desired specifications. For example, a storm window one would want strong magnetic attraction to provide a substantially complete seal against the leakage of air. However, in certain applications it is desired that the fixture detach under a certain load or applied force, thus a strength of magnet or combination of magnet strengths would be utilized that allows for some or all of the fixture to detach as desired. Using an anisotropic magnet increases flux lines which in turn gives more predictable shear holding as the panel is deflected under a load. Also cost is lowered by lowering the mass making it more economical.

For example, a magnet for use in the compositions and methods described herein can have a coercive force of (Oersted) of from about 1 Oe to about 3,000 kOe; and/or a magnetic field strength (BHmax×10⁶ (MGOe)) of from about 0.01 to about 100 MGOe. In a preferred embodiment, the magnetic strip has a magnetic field strength of about 1.8 MGOe; and a coercive force of about 2,390 kOe.

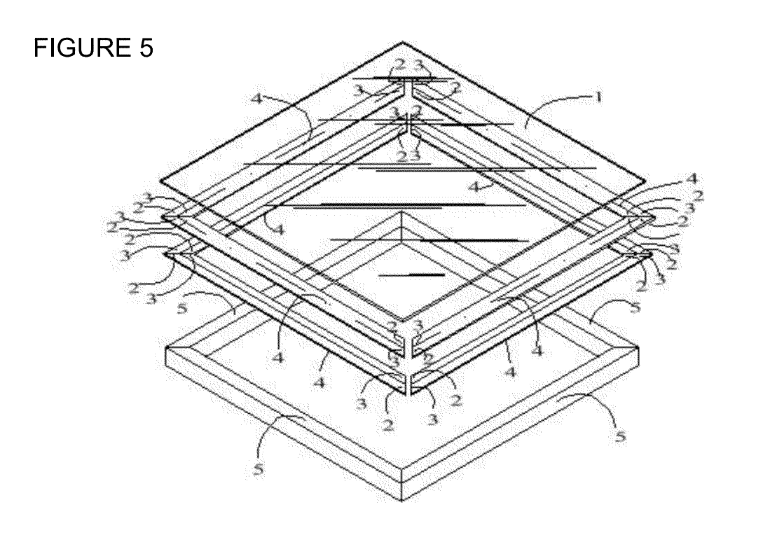

In any of the aspects or embodiments described herein, the magnetic strip tape may comprise one or more bipolar axially disposed magnetic strips aligned parallel and affixed to each other (see, e.g., FIG. 5). For example, the magnetic strip can comprise 2, 3, 4, 5, 6, 7, 8, 9, 10 or more magnetic strips juxtaposed and/or bonded together into a single strip. In addition, in any of the aspects or embodiments described herein, the magnetic strip can be an anisotropic magnetic strip. For example, in any of the aspects or embodiments described herein, the magnetic strip can be a bipolar anisotropic/uniaxial anisotropy dual strip magnet.

### EXAMPLES

Window Cover

It has been proposed that magnets be used to attach covers, screens, nets and various other objects to, e.g., a window. In this type of arrangement, a metal strip extends around the window frame to adhere to magnets or magnetic tape carried on the window cover. Due to the unattractive appearance of the metal strip, the aesthetic problems are much the same as in the case of more conventional fastening devices. Also, if individual magnetic elements are used, gaps are presented between the cover and the frame, and the effectiveness of the cover suffers accordingly. The use of a metal strip creates further problems in that it is expensive and difficult to install.

Storm windows have proven to be highly effective in preventing leakage of air through windows and have been widely used in recent years, primarily due to the increased emphasis that has been placed on energy efficiency. Perhaps the principal problem associated with most storm windows is their lack of aesthetic appeal. For example, inside storm windows are temporarily held in place by conventional fasteners such as clamps and the like. Fastening elements of this type are so unattractive that they detract significantly from the overall appearance of the window. Primarily for this reason, inside storm windows have not been used as widely as they might be otherwise, nor have other types of window covers.

Interior storm windows with magnetic attachments can be attached to existing windows using magnetic strip attachments. The present description provides a complete seal based on the configuration of the magnetic strips. Using a mitered frame work and magnetic seal on the sealing membrane. Strip magnets are adhered to an interior storm window pane or a framed window pane and then strip magnets are adhered to an applied frame or existing frame of the window to which the interior storm window is to be applied. The magnetic strips are to be applied by adhesive which are approved by the manufacturer and the magnet provider.

The strip magnets, if oriented correctly, creates a magnetic seal between the magnetically attached strip magnet adhered to the window membrane material and the strip magnet attached to the fixed frame. Orienting the two adhered strip magnets, one attached to the window panel and one to the frame, in such a way to include polar attraction within the corners provides a superior corner seal in this type of application.

In the case of a storm window, the tape strips can be painted, antiqued, laminated or otherwise treated to give them a pleasant appearance that is compatible with the appearance of the window to provide a much more attractive storm window than has been achieved in the past.

Referring now to FIG. 5, numeral 5 designates a conventional window frame having vertical opposite sides, and a top frame portion and a bottom frame portion.

In accordance with the present invention, an inside storm window 1 is magnetically mounted to the window frame 5 by two magnetic tape strips 4. The tape strips 4 are identical to one another, and examples of suitable types of tape are tapes that are commercially available from the B. F. Goodrich Company, Flexmag Industries, Inc., and from the 3M Company. The magnetic tape is flexible and is normally provided in a roll. The magnetic strips preferably have a magnetic side and an opposite adhesive side carrying a layer of pressure sensitive adhesive. The adhesive sides of the tape are normally covered by a release liner, which may be peeled off of the tape to expose the adhesive.

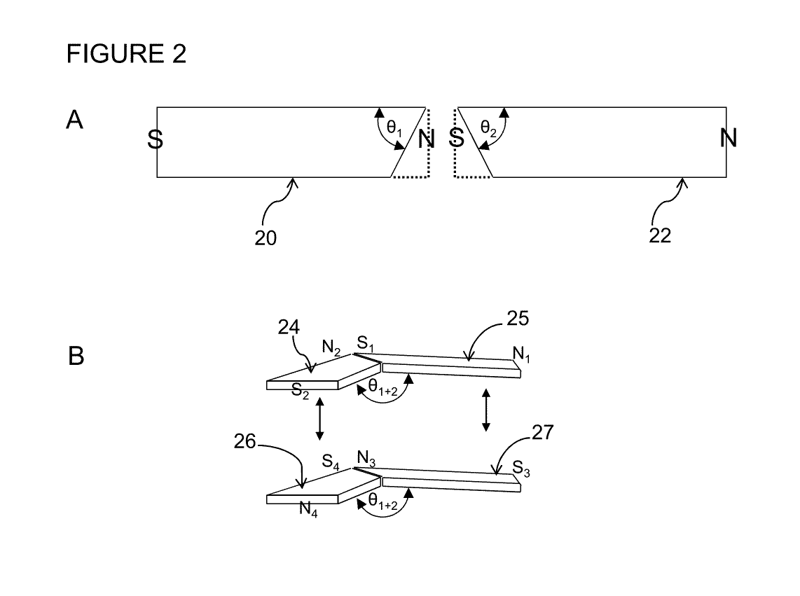

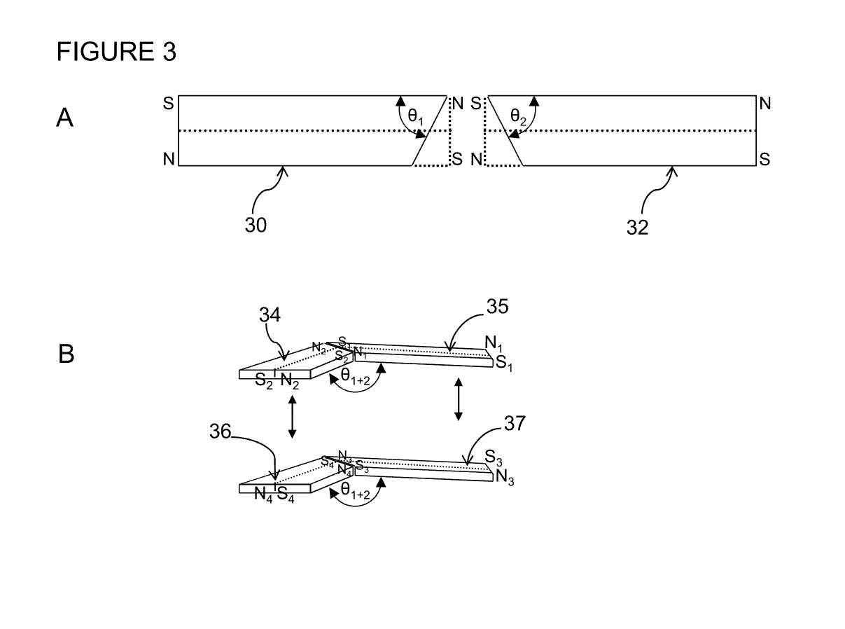

The magnetic strips 4 are applied to the window frame 5 by removing the release liner from the adhesive side of vertical portions of the strip and applying the adhesive sides of these portions to the respective frame sides 5 along the outer edges thereof, as shown in FIG. 5. As exemplified by FIGS. 2 and 3, the magnetic strips are mitered to form a miter joint in the corners of the frame 5 (FIG. 5). In this manner, strip 4 extends in a continuous manner around the window frame 5 with the magnetic side of the tape strip facing inwardly into the room and away from frame 5.

A second tape strip is then applied to the first strip affixed to the frame 5 or to the window 1 with the magnetic side of the second strip in face to face contact with the magnetic side of the first strip, including at the mitered corners. To accomplish this, are adjusted in their positions until the magnetic sides of the tape strips magnetically adhere to one another along their entire lengths. In certain embodiments, when the second strip has been applied to the first strip in the manner indicated, the release liner is removed from the second strip to expose its adhesive side which faces inwardly into the room. The storm window 1 may be any suitable type of material and may be either flexible or rigid. In one form of the invention, the storm window is formed from polyester film approximately five millimeters thick. With the adhesive side of the second strip exposed, the window 1 is pressed against the strip such that it is applied to the adhesive side of the second strip, as shown in FIG. 5.

Since the second tape strip is positioned such that it magnetically adheres to the first tape strip completely around the window, especially at the mitered corners, a tight seal is provided between the storm window and the window frame. Consequently, there are no air gaps presented through which cold air could leak to detract from the effectiveness of the storm window in sealing against leakage through the window. The magnetic tape strips are preferably anisotropic strip magnets having multiple alternating poles juxtaposed along one side along the length of the strip, with the polarity alternating across the width of the tape, since this type of magnetic tape has more attractive power than other types such as tapes having one face which is a south pole and another face which is a north pole. Consequently, if two strips of magnetic tape are applied to one another randomly, a south pole portion of one tape may be applied to a south pole portion of the other tape such that the tape strips would repel one another. Should this occur at any point along the strips, a gap results to permit leakage of air past the storm window.

It is pointed out that no areas of repulsion can be presented in the composition as described herein. The polarities of the two strips are oriented such that the north pole areas of one strip are disposed against the south pole areas of the other strip and vice versa, including situations in which the strip has multiple alternating poles aligned side by side on one face. Thus, there are no air gaps presented at any point on the storm window. The magnetic faces are magnetically attracted around the entirety of the window to establish an effective seal which prevents leakage of air in any appreciable quantity.

The storm window 1 can be removed and stored when not needed. Replacement of the storm window is carried out simply by applying it to the frame such that the proper portions of the tape strips are in contact with one another. Again, an effective seal is formed between the two tape strips since it is assured that they magnetically attract one another completely around the window.

The storm window pane is preferably a thin polyester film such as the material commercially available from the DuPont Company under the “Mylar” trademark. However, it is to be understood that other types of materials are equally well suited to the invention, and that more rigid window panes may be used if necessary or desirable. It should also be understood that various types of magnetic tape may be used to mount the storm window to the window frame. Either or both tape strips can be painted, laminated, antiqued or otherwise treated to match with the frame and thus provide an attractive window structure.

If a rigid window pane constructed of glass or Plexiglas material is used instead of the more flexible “Mylar” material, it may be desirable to permanently attach one tape strip to the pane prior to attaching the other strip permanently to the window frame. In this procedure, one strip is adhesively attached to the border of the pane, the other strip is applied face to face with the first strip and adjusted until the strips are aligned in magnetic polarity, and only then is the second strip adhesively attached to the frame. This method of installation assures that the tape will be properly arranged in polarity to result in effective sealing of the pane to the window frame.

If the window frame has a sill at the bottom, an additional molding can be provided for attachment between the vertical portions of the frame at a location immediately above the sill. This additional molding provides a surface to which the lower horizontal tape portion is adhesively applied.

Although the invention has been described in connection with an inside storm window, it should be understood that it is equally useful to hold outside storm windows, insect screens and other similar articles in place covering various types of openings such as those present in doors, automobile vehicles, boats and other structures.

General Aperture Cover

Referring to FIG. 6, numeral 60 designates a typical conduit (e.g., air/gas or water) having an opening or aperture. The figure shows an opening or aperture that is generally rectangular; however, any geometric shape having at least one corner is amenable for use with the presently described compositions and methods. In the rectangular aperture illustrated, the aperture has vertical opposite sides, and a top portion and a bottom portion.

In accordance with the present invention, a cover or panel 64 magnetically mounted to the conduit 60 by two magnetic tape strips 66/68. The magnetic strips 66/68 are applied to the conduit 60 by removing the release liner from the adhesive side of vertical portions of the strip and applying the adhesive sides of these portions to the respective edges as shown in FIG. 6. As exemplified by FIGS. 2 and 3, the magnetic strips are mitered to form a miter joint in the corners of the conduit frame (FIG. 6B). In this manner, strip 66/68 extends in a continuous manner around the conduit frame with the magnetic side of the tape strip facing away from fhe conduit frame.

A second tape strip is then applied to the first strip affixed to at least a portion of the conduit frame or to at least a portion of the cover or panel 64 with the magnetic side of the second strip in face to face contact with the magnetic side of the first strip, including at the mitered corners. In the exemplary embodiment illustrated in FIG. 6, the cover or panel 64 is permanently fastened, e.g., via a hinge, such that the cover or panel 64 can move about the hinge axis. In addition, in this embodiment, the cover or panel has two positions, a closed position (FIG. 6A), and an open position (FIG. 6B). In a resting position (6A), the cover or panel 64 is releasably (i.e., reversibly) sealed preventing the passage of air/gas or liquid. In response to a sufficient force (6B) (e.g., forced air/gas or liquid), the pull strength of the magnetic strips is overcome by the positive pressure resulting in the opening of the cover or panel 64. The opening of the cover or panel 64, therefore, allows for the passage of air/gas or liquid through the conduit. In any embodiment as described herein, the cover or panel 64 may be any suitable type of material, size, and may be either flexible or rigid.

It is contemplated that in certain embodiments, the conduit frame and/or cover or panel 64 comprises magnetic strips having differing magnetic field strengths such that a greater degree of control over the opening threshold is possible.

Those skilled in the art will recognize, or be able to ascertain using no more than routine experimentation, many equivalents to the specific embodiments of the invention described herein. Such equivalents are intended to be encompassed by the following claims.

It is understood that the detailed examples and embodiments described herein are given by way of example for illustrative purposes only, and are in no way considered to be limiting to the invention. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present invention will be apparent from the appended claims. Moreover, those skilled in the art will recognize, or be able to ascertain using no more than routine experimentation, many equivalents to the specific embodiments of the invention described herein. Such equivalents are intended to be encompassed by the following claims.

What is claimed is:

1. A reversibly attachable fixture comprising at least one corner and at least one surface, and including a magnetic strip affixed to a surface of the fixture, wherein the magnetic strip is mitered at the at least one corner of the same surface.

2. The fixture of claim 1, wherein the magnetic strip is affixed to at least one surface and apposed with an edge of the fixture.

3. The fixture of claim 2, wherein the magnetic strip is affixed to at least one surface and apposed with each edge of the fixture

4. The fixture of claim 3, wherein the magnetic strip is affixed to at least one surface and runs substantially the entire length of each edge of the fixture.

5. The fixture of claim 4, wherein the magnetic strip is affixed to at least one surface and runs the entire length of each edge of the fixture.

6. The fixture of claim 1, wherein the fixture is a storm window.

7. The fixture of claim 1, wherein the fixture is a vent.

8. A device comprising a reversibly attachable fixture comprising
(i) a body defining at least one corner and at least one surface, and including a first magnetic strip affixed to at least one surface apposed with an edge of the body, wherein the first magnetic strip is mitered at the at least one corner of the same surface; and
(ii) a fixture comprising at least one corner and having at least one surface, and including a second magnetic strip affixed to at least one surface of the fixture, wherein the second magnetic strip is mitered at the at least one corner of the same surface,
wherein the first and second magnetic strips are positioned such that said first strip is generally coextensive with the second strip, and wherein the magnetic poles of the first strip are in registration with the opposite magnetic poles of the second strip to maximize the magnetic attraction between the first strip and second strip.

9. The device of claim 8, wherein the body is a window frame and the fixture is a storm window.

10. The fixture of claim 1, wherein the body is a conduit and the fixture is a vent.

11. A storm window comprising at least one corner and at least one surface, and including a multipolar, anisotropic magnetic strip affixed to a surface of the storm window, wherein the magnetic strip is mitered at the at least one corner of the same surface, wherein the window is capable of being reversibly attached to a window frame having a multipolar, anisotropic magnetic strip affixed to it with mitered corners, and wherein the magnetic strip affixed to the window frame are oriented such that their poles are opposite to those affixed to the storm window.

12. A method of reversibly attaching a storm window to a rectangular window frame comprising the steps of: (a) selecting a continuous and substantially planar surface on the window frame; (b) providing first and second magnetic strips, each strip having an adhesive side and an opposite magnetic side, the magnetic side having multiple alternating north and south magnetic poles thereon; (c) mitering the first and second magnetic strips to form a miter joint in at least one corner of the window frame and storm window; (d) applying the adhesive side of the first strip to a surface on the storm window in a pattern to generally continuously surround the window frame; (e) positioning the magnetic side of the second strip on the magnetic side of the first strip such that the second strip is generally coextensive with the first strip; (f) adjusting the second strip in relation to the first strip to position the magnetic poles of the second strip in registration with opposite magnetic poles of the first strip along the sides and mitered corners to maximize the magnetic attraction between the first and second strips; and (g) thereafter placing the storm window in contact with the adhesive side of said second strip such that said storm window is removably held by the magnetic attraction between the magnetic sides of the first and second magnetic strips such that the magnetic attraction is sufficient to create a seal that prevents the passage of air and/or liquid.

13. A kit comprising a container including the composition of claim 11 and instructions for its use comprising the steps of: (a) selecting a continuous and substantially planar surface on a window frame; (b) providing first and second magnetic strips, each strip having an adhesive side and an opposite magnetic side, the magnetic side having multiple alternating north and south magnetic poles thereon; (c) mitering the first and second magnetic strips to form a miter joint in at least one corner of the window frame and storm window; (d) applying the adhesive side of the first strip to a surface on the storm window in a pattern to generally continuously surround the window frame;
(e) positioning the magnetic side of the second strip on the magnetic side of the first strip such that the second strip is generally coextensive with the first strip; (f) adjusting the second strip in relation to the first strip to position the magnetic poles of the second strip in registration with opposite magnetic poles of the first strip along the sides and mitered corners to maximize the magnetic attraction between the first and second strips; and (g) thereafter placing the storm window in contact with the adhesive side of said second strip such that said storm window is removably held by the magnetic attraction between the magnetic sides of the first and second magnetic strips such that the magnetic attraction is sufficient to create a seal that prevents the passage of air and/or liquid.
